(19) United States
(12) Patent Application Publication
(10) Pub. No.: US 2024/0011577 A1
(43) Pub. Date: Jan. 11, 2024

(54) METHOD AND SYSTEM FOR AUTOMATIC OPERATION AND FUNCTIONAL VERIFICATION OF LINE VALVES INSTALLED IN FLUID DISTRIBUTION NETWORKS

(71) Applicant: I.S.I.F. S.R.L., Castelfranco Piandisco (IT)

(72) Inventor: Mauro Odori, Castelfranco Piandisco (IT)

(21) Appl. No.: 18/251,610

(22) PCT Filed: Nov. 9, 2021
(86) PCT No.: PCT/IB2021/060357

§ 371 Date: May 3, 2023

(30) Foreign Application Priority Data
Nov. 9, 2020 (IT) 102020000026648

(51) Int. Cl. F16K 31/53; F16K 31/04; F16K 37/00

(52) U.S. Cl. CPC F16K 31/535; F16K 31/041; F16K 37/0041

(57) ABSTRACT

The method includes periodical controlled operation of line valves (Vs) installed in fluid distribution networks to prevent them from blocking due to long periods of inactivity. The operation includes one or more partial rotations of closing and subsequent reopening, necessary to avoid blocking. In the system (1) that implements the method, each line valve (Vs) is provided with a gear motor assembly (2), capable of manipulating, in one direction or the other, the corresponding rotation driver (Cr). A functional check of the line valve (Vs) and of the geared motor group (2) is also provided together with the controlled manipulation.

### TECHNICAL FIELD

The present invention relates to the technical field of networks designed for transportation and distribution of fluids, such as gas pipelines, oil pipelines, water pipelines and the like.

The pipelines that form these networks very often extend for kilometers and branch off in multiple directions covering even very large territorial extensions.

### Background Art

Line valves, usually present in a quite large number, are situated along the above-mentioned pipelines in order to section-off specific parts of the corresponding network and/or to stop the flow of fluid downstream of a certain point, for example for maintenance operations.

The dimensions of the above-mentioned line valves are set to match to the diameter of the associated pipelines, which may vary, approximately, from four to sixteen inches. These valves are usually of the ball type, but may also be of a different type. For example, it is easy to find valves of the so-called “rubber wedge” type in waterworks. Basically all types of line valves can be operated from outside, to open and close, by means of rotation mechanisms controlled by a hand wheel, lever or other type of handle. These mechanisms allow progressive and partial opening and closing, in order to regulate the flow of the fluid circulating in the line, if necessary.

### Technical Problem

In many cases, the pipelines of a transport or distribution network are located below the ground level, and each line valve is accessible from a related inspection pit, closed for example by a manhole.

If it is not requested to close the line valves, i.e. under normal operating conditions of the respective fluid distribution network, the line valves are in the open position and this condition may persist for even very long periods of time, several months or even years.

This long inactivity of the valves would most likely lead to their blocking. Therefore, it is a common practice to periodically send one or more operators to inspect each valve and to rotate the external mechanism that controls it, in order to obtain first a partial closing and then, immediately afterwards, a rotation in the opposite direction, in order to open it completely again.

In this way, the flow is never interrupted, but the valve is kept in the correct operation position in case it is necessary, for any reason, to bring it to the closed position.

Moreover, it is easy to understand that for large valves, even a partial blocking may require the application of a considerable torque to move the valve, which may be very difficult to be applied by an operator in some allocations.

As it can be easily understood, such a procedure presents a lot of disadvantages, in terms of manpower, time, costs, scheduling needs and, sometimes, logistics, since it is not uncommon that at least part of the line valves of a transport or distribution network can be located in places that are difficult to access, for various reasons.

Blocking of line valves in the absence of periodical maintenance is a real and severe problem so that recently the companies managing distribution networks have been obliged to carry out a compulsory periodical handling cycle, usually at least every 1-2 months.

In various industrial fields, devices are known for power operating of valves or gate valves installed on a pipeline in order to interrupt the flow of a fluid, electrically operated in sites where electric mains are available, allowing the aforementioned valves or gate valves to be controlled to open or close.

Furthermore, the U.S. Pat. No. 10,520,103 B1, in the name of Mohammad Tahi Fatehi et al. describes a system for automatic emergency shutting off of the flow of gas in a pipeline in the event of an earthquake, provided with a special “P” seismic wave detector. The system makes it possible to totally shut off the flow of gas in a section of pipeline at risk as soon as it detects an earthquake with effects exceeding a predefined threshold, to prevent gas leakage in case of ruptures in the pipeline caused by the earthquake.

However, the invention disclosed in the above-mentioned patent does not address the technical problem related to the periodic maintenance of the line valves, nor does it provide solutions to prevent them from blocking after a long period of non-use.

### Objects of the Invention

Therefore, it is an object of the present invention to propose a method and a system for the automatic operation and functional check of line valves situated in fluid distribution networks, which avoid the need to physically go to the places where each of the valves is located in order to perform those periodic maintenance rotations, in one direction and the other, which serve to maintain the operation capability of the valves.

Another object of the invention is to provide a method and a system which is capable, for each of the controlled line valves, of sending a report concerning the maintenance rotation and its success to a remote operation center.

An additional object of the invention relates to a method and a system which can detect further functional parameters of each of the line valves during the periodic maintenance rotations, in order to ascertain its state of overall efficiency, sending the obtained data to said operation center for evaluation.

A still further object of the invention is to realize a first configuration of the system, in which said periodic maintenance rotations are automatically programmed on-site in each of the line valves, independently from the others.

A further object of the invention is to propose a second configuration of the system, in which the execution of said periodic maintenance rotations is controlled by the same remote operation center aimed at receiving, in return, reports on the outcome of the manipulation.

A yet further object of the invention concerns the possibility of providing the system with means that allow to make independent, from the point of view of energy requirements, each of the positions where a line valve is situated, so as to make the functionality of the system independent from the possibility of connecting, or not, to a power supply.

### SUMMARY OF THE INVENTION

These and other objects are fully achieved by a method for automatic operation and functional check of line valves, e.g., ball valves, situated in pipelines of fluid distribution networks, said line valves being kept in an open configuration under normal operating conditions of the respective fluid distribution network, and being of the type provided with a rotation driver external to the valve body aimed at opening and closing the valve.

The foregoing method includes cyclic maintenance operations of each of said line valves, with each of said operations comprising:
sending of input signals, transmitted by radiofrequency from a remote operation center to an electronic processing and control unit provided in each line valve;
activation and stopping according to predefined parameters, controlled by said electronic processing and control unit, of a gear motor assembly associated mechanically to said rotation drive, so that the latter causes at least a partial closing and at least a subsequent immediate reopening of the corresponding line valve.

These and other objects are likewise achieved by a system for automatic operation and functional check of line valves, e.g., ball valves, situated in pipelines of fluid distribution networks, said line valves being kept in an open configuration under normal operating conditions of the respective fluid distribution network, and being of the type provided with a rotation driver external to the valve body aimed at opening and closing the valve.

The above mentioned system includes:
a gear motor assembly for each line valve to be operated, the gear motor assembly being associated with the rotation driver of the corresponding line valve and aimed at manipulating it in one direction or the other;
at least one sensor element, associated with the gear motor assembly, provided for detecting the angular amplitude and the direction of the rotation imposed to the rotation driver of the line valve;
an electronic processing and control unit, provided to activate/deactivate the gear motor assembly, according to predefined modes, and to receive feedback signals provided by the sensor element;
a radio-frequency transceiver interfaced with the electronic processing and control unit and aimed at communicating with a remote operation center, in order to send thereto a report concerning the outcome of each single rotating manipulation carried out on the rotation driver of the respective line valve.

The above described summary statements are to be understood as not necessarily limiting the invention so that there may be other cases where particular steps or elements are omitted or modified.

### BRIEF DESCRIPTION OF THE DRAWINGS

The characteristics of the invention will become apparent from the following description of a method for automatic operation and functional check of line valves situated in fluid distribution networks, as well as embodiments of the system for implementing the above mentioned method, as indicated in the object, in accordance with the contents of the claims and with help of the enclosed figures, in which:

FIG. 1 is a schematic overall view of a basic embodiment of the system in question, applied to a normally open line valve;

FIG. 2 is a view similar to FIG. 1, of a more complete version of the system.

### DESCRIPTION OF EMBODIMENTS OF THE INVENTION

In the above figures, a system for the automatic operation of line valves Vs proposed by the present invention, as a whole, has been indicated by reference number 1.

For sake of simplicity, the enclosed figures illustrate only one of said line valves Vs, provided to be associated with pipelines T and situated at several points in fluid distribution networks, such as gas pipelines, oil pipelines, water pipelines and the like.

Although the invention can be advantageously applied to all types of line valves Vs normally used in fluid transport and distribution networks, farther on, for simplicity's sake and by way of example, reference will be made to ball valves Vs, which in any case are the most commonly used type of line valve.

As already mentioned in the introduction, the diameter of pipelines T can vary, approximately, from four to sixteen inches.

Said pipelines T are often buried and the relative ball valves Vs are situated in special inspection wells P, closed at the top by a cover K.

According to the prior art, each of said ball valves Vs is provided with a rotation driver Cr external to the body of the valve, aimed at opening and closing the latter, generally comprising a hand wheel having a diameter proportionate to the dimensions of the ball valve Vs, and to the force required to manipulate it, preferably without tools.

The system 1 proposed by the present invention avoids the necessity to go physically to the places where each of said ball valves Vs is located in order to carry out those periodic maintenance rotations, mentioned in the introduction, which serve to maintain the operation capability of the valves.

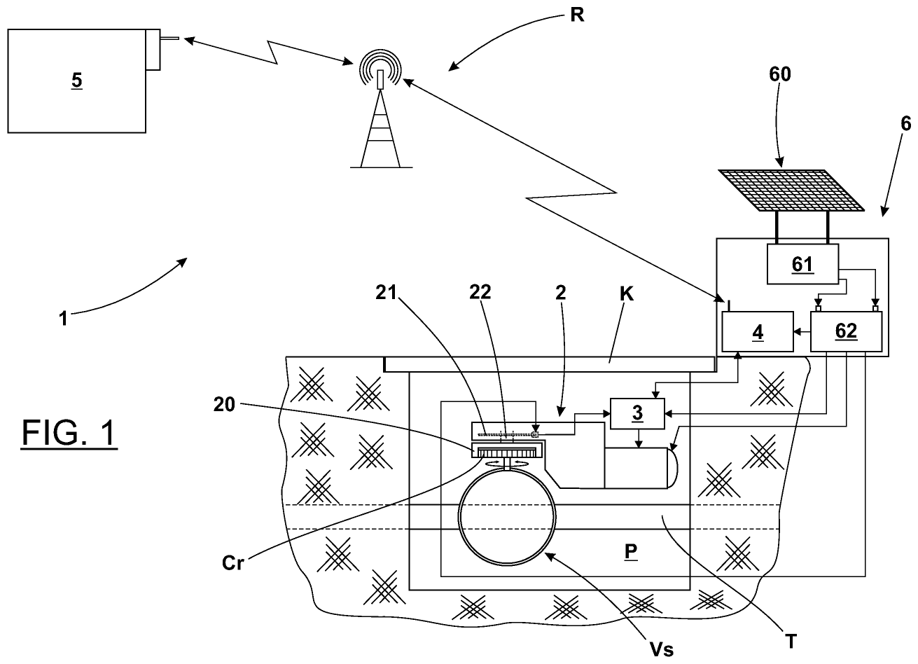

To this end, the system 1, in the simpler embodiment illustrated in FIG. 1, comprises, for each ball valve Vs to be operated, a gear motor assembly 2, associated with the rotation driver Cr of the corresponding ball valve Vs and suitable for operating the rotation driver in one direction or the other, to open and close the valve.

The gear motor assembly 2 is preferably of the type in which gears (of known, not detailed type) are provided, suitable for obtaining a high reduction ratio between the revolutions of the motor and those of the corresponding manipulating element 20 which operates the above mentioned rotation driver Cr, so as to considerably increase the value of the torque exerted on the latter.

The gear motor assembly 2 carries associated thereto at least one sensor element 21, for example a known encoder keyed on the same axis 22 to which said manipulating element 20 is keyed; the sensor element 21 is provided for detecting the angular amplitude and the direction of the rotation imposed by the manipulating element 20 on the rotation driver Cr of the ball valve Vs.

For each ball valve Vs, there is also provided an electronic processing and control unit 3, capable of determining the activation and deactivation of the corresponding gear motor assembly 2, according to predefined modes, both in terms of time and direction of rotation.

The electronic processing and control unit 3 is also capable of receiving the feedback signals provided by the aforementioned sensor element 21, which indicates the actual rotation imposed to the rotation driver (hand wheel) Cr.

Advantageously, both the gear motor assembly 2 and electronic processing and control unit 3 are housed in the well P.

Internally or externally with respect to the well P of each ball valve Vs, a transceiver apparatus 4 is provided, operating in radiofrequency, interfaced to said electronic processing and control unit 3 and aimed at communicating with a remote operation center 5.

Preferably, said transceiver apparatus 4 is of a type suitable for connecting, in a widely known manner, to a cellular telephone network R, schematically shown in the figures, and in particular to a data network, for example to the Internet network.

If the ball valve Vs is located in an uninhabited place, outside the coverage range of the cellular telephone network R, it is envisaged to use a transceiver apparatus capable of connecting to a satellite telephone network.

Alternatively, the transceiver apparatus is aimed at connecting to a local area network, where available, for example using the well-known Wi-Fi technology, and, through the local area network, to the remote operation center 5.

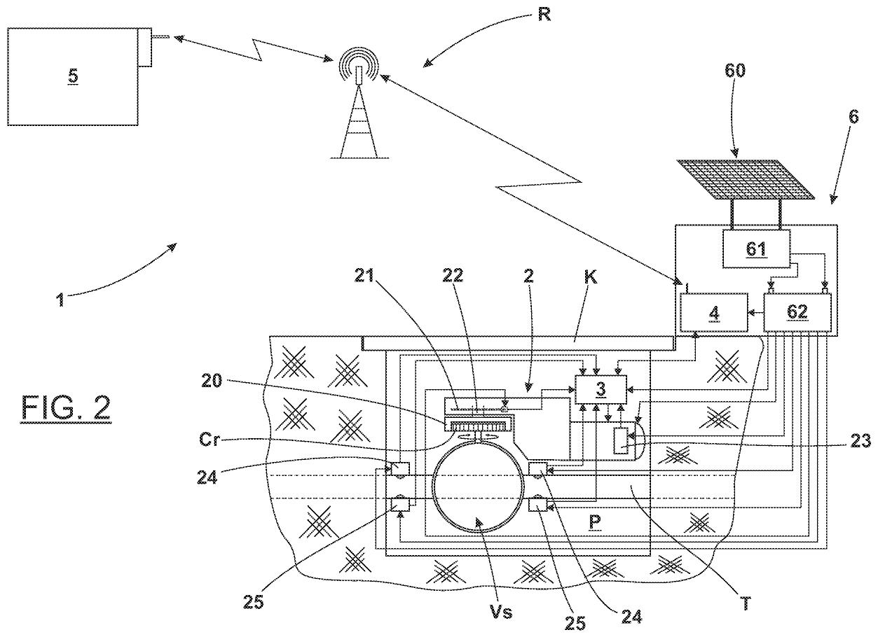

FIG. 2 illustrates a more complete version of the just described system 1, for the acquisition of further parameters inherent to the overall efficiency status of each ball valve Vs, by means of one or more additional sensor elements.

It is to be noted that, for sake of simplicity, FIG. 2 shows all the above mentioned additional sensor elements; obviously, it is understood that, in practice, all possible combinations in which each of said sensor elements may be present or absent may be envisaged.

The above mentioned additional sensor elements include:
a second sensor element 23 associated with said gear motor assembly 2, aimed at detecting the electric power absorbed by the latter in order to carry out the rotations of the rotation driver Cr and to send a corresponding signal to said electronic processing and control unit 3
at least a third sensor element 24 associated with the corresponding pipe T, upstream and/or downstream of the above mentioned ball valve Vs, aimed at detecting the flow rate of the fluid flow transported by the pipe T and sending a corresponding signal to said electronic processing and control unit 3;
at least a fourth sensor element 25 associated with the corresponding pipe T, upstream and/or downstream of the above mentioned ball valve Vs, aimed at detecting the pressure of the flow of fluid transported by the pipe T and sending a corresponding signal to said electronic processing and control unit (3).

In order to overcome the contingent problem of energy requirements in all those applications in which an electric line is not available nearby, the system 1, as illustrated, advantageously comprises a module 6 for the supply of electric energy in which at least one photovoltaic panel 60, a battery charger 61 and at least one accumulator 62 are provided.

The latter is suitably wired to supply electric current to the gear motor assembly 2, sensor element 21, electronic processing and control unit 3 and transceiver apparatus 5, during the active phases involving each ball valve Vs (FIG. 1).

Naturally, the accumulator 62 is wired to supply electric current to the aforementioned second, third and fourth sensor elements 23, 24, 25, if provided (see FIG. 2).

In a first version applicable both to the simple version of FIG. 1 and to the more complete version of FIG. 2, the system 1 includes said remote operation center 5 supervised by an operator who, according to a pre-established maintenance schedule, selectively sends an input to those electronic processing and control units 3 relating to the ball valves Vs that must execute the running maintenance program, which comprises a partial closing and a subsequent immediate reopening of the ball valve Vs.

Each electronic processing and control unit 3 is arranged to prepare a report concerning the outcome of each individual rotating manipulation performed on the rotation driver Cr of the ball valve Vs, based on the signal provided by the sensor element 21.

The report is then sent to the remote operation center 5 by means of said transceiver apparatus 4.

Therefore, in practice, since normally there is a plurality of ball valves Vs in the distribution network, the reports of each ball valve Vs will be sent to the remote operation center 5.

In a second possible embodiment, the system 1 envisages that each electronic processing and control unit 3 incorporates a software capable of autonomously governing a program for keeping operative the respective ball valve Vs, which includes, similarly to what has been said above, a partial closing and a subsequent immediate reopening of the same valve, at predefined time intervals.

Also in this embodiment, each electronic processing and control unit 3 is arranged to draft a report to be sent to the remote operation center in real time, by means of the respective transceiver apparatus 4.

The method for automatic operation of the ball valves Vs according to the invention, that can be carried out by the above described system 1, includes sequences of cyclical operations for maintaining the efficiency of each of said ball valves Vs, to be carried out remotely at predefined time intervals. Each sequence of operations is carried out periodically and independently for each of the valves Vs operating in the line.

In particular, for each valve Vs, each of the aforementioned sequences of operations comprises:
sending input signals, transmitted from the remote operation center 5 to the processing and control unit 3 provided in each ball valve Vs, said input signals containing activating controls for a manipulation cycle for the above-mentioned valve. The above-mentioned activating controls may comprise a simple start control for a predefined manipulation cycle whose parameters are stored in the same processing and control unit 3, or a sequence of instructions containing parameters provided specifically for that particular operation. In particular, the parameters that may be provided, include for example the angle of rotation when closing the valve Vs, the speed of rotation of the valve if the provided gear motor assembly 2 allows its adjustment, the downtime before reopening, and the instruction to reopen the valve Vs, with return of the valve to the open position;
the activation and arrest according to the above mentioned parameters, controlled by said electronic processing and control unit 3, of the gear motor assembly 2 mechanically associated to the rotation driver Cr, so that the latter imposes at least a partial closing, by a predetermined opening angle, and in any case such as not to substantially compromise the flow through the valve Vs, and at least a subsequent immediate reopening of the same ball valve Vs. The aforementioned activating controls may comprise the execution of a plurality of consecutive partial closing and reopening cycles, in such a way as to contribute to improving the smoothness of the movements, both of the valve Vs and gear motor assembly 2, eliminating any microscales and redistributing the lubricating material in the moving parts of the same gear motor assembly 2.

The method also envisages that, during the aforesaid activation phase of the gear motor assembly 2, the angular amplitude and, if necessary, the direction of the rotations imposed to said rotation driver Cr are detected by the first sensor 21 (encoder); the angular amplitude may be detected, if necessary, moment by moment or at predefined time intervals, in order to generate an opening and possibly closing curve on a time basis, in order to obtain information on the constancy of the rotation motion of the valve Vs, and consequently on possible undesired stresses in the action of the gear motor assembly 2. Moreover, a report concerning the result of the rotating manipulations carried out on the rotation driver Cr of the respective ball valve Vs is sent by radiofrequency to said remote operating unit 5.

If the system 1 comprises the second sensor element 23, the method includes, likewise during the aforementioned activation phase of the gear motor assembly 2, the detection of the electric power absorbed by the latter to perform said rotations of the rotation driver Cr; if necessary, it is possible to detect the electric absorption moment by moment, or at predefined time intervals, in order to generate an absorption curve, in closing and possibly in opening, of the gear motor assembly 2, which can be compared with the aforementioned rotation curve on a time basis described above, in order to verify any anomalies in the displacements and in the mechanical stresses required to perform the rotating operations. It is also contemplated to send, by radiofrequency, a report concerning the value of said power consumption to said remote operation center 5, which will be compared with stored reference parameters to assess the overall efficiency status of the respective ball valve Vs.

In addition or alternatively to what has just been said, if the system 1 is provided with at least a third sensor element 24 associated with the corresponding pipe T, the method includes, likewise during the above mentioned activation phase of the gear motor assembly 2, the detection of the flow rate of the fluid transported by said pipe T upstream and/or downstream of the respective ball valve Vs; moreover, it is also contemplated to send, by radiofrequency, a report concerning the value of said flow rate to said remote operation center 5 in order to compare this value with stored reference parameters to assess the overall efficiency status of the above mentioned ball valve Vs.

In addition or alternatively to what has just been said, if the system 1 is provided with at least a fourth sensor element 25 associated with the corresponding pipe T, the method includes, likewise during the above mentioned activation phase of the gear motor assembly 2, the detection of the flow pressure of the fluid transported by said pipe T upstream and/or downstream of the respective ball valve Vs; also in this case, it is contemplated to send by radiofrequency a report concerning the value of said pressure to said remote operation center 5 in order to compare this value with stored reference parameters to assess the overall efficiency status of the above mentioned ball valve Vs.

The phases of detection of rotation, consumption, pressure, flow and flow rate, which, as already mentioned, can be combined according to specific monitoring requirements of the valves Vs, allow to obtain a total control on the state of the valves Vs, powering and mechanical means that operate them, providing the operators of the remote control unit with a perfectly updated knowledge of the current state of each valve Vs of the line, and possibly allowing the operators to schedule maintenance operations on-site if necessary.

An operation version of the method envisages that the entire sequence of operations of automatic operation and functional check is programmed upon the installation or program update in the processing unit 3 associated with each valve Vs, and that the above described sequences of operations of automatic operation and functional check are carried out automatically at predefined time intervals, controlled by the same processing unit 3.

Likewise in this case, suitable program procedures resident in the processing unit draft a functional check report and transmit it to the remote operation center 5. It is obvious that, if the latter does not receive the periodical report from a valve Vs, or if the report contains anomalies with respect to the detected nominal values or curves, it will mean that this particular valve needs an “on-site” check and maintenance intervention.

Further operation versions of the method, made possible by the conformation of system 1 described above, comprises:
an on-site operator, provided with suitable control apparatus, such as a handheld computer, who can communicate directly with a corresponding electronic processing and control unit 3 to control a ball valve Vs, bypassing the remote operation center 5;
the remote operation center 5 that is able to selectively send an input to those electronic processing and control units 3 related to the ball valves Vs that must be totally closed, to isolate predefined sections of the network in case of emergency, for example in the presence of accidental events such as breakages, earthquakes or other atmospheric calamities.

The above description makes evident all the advantageous aspects that the method and the system proposed by the present invention offer, allowing to automatically operate all the ball valves located in a fluid distribution network, without the necessity to physically go to the places where each of them is located, so as to perform those periodic maintenance rotations, in one direction and in the other, which serve to maintain the manipulability of the valves themselves.

Among the advantages of the system, the possibility to allow each of the ball valves to send a report concerning the maintenance rotation and its success to a remote operation centre is of fundamental importance.

Likewise, other advantages are obtained with the described additional sensors that monitor the power absorbed by the motor, the flow rate and/or the pressure of the fluid flow upstream and/or downstream of the ball valve, so that the method is implemented by performing checking phases that highlight any abnormal or non-standard value found, and allow the evaluation of the real state of efficiency of the valve, putting in place, if necessary, preventive maintenance operations to avoid more serious problems.

For each installation it will be possible to choose, according to convenience, the configuration of the system in which the execution of said periodic maintenance rotations is automatically programmed on-site on each ball valve, independently from the others, or the configuration in which the execution of said periodic maintenance rotations is controlled by the same remote operation center aimed at receiving, in return, reports on the outcome of the valve manipulation.

Another important advantage derives from the fact that each station where a ball valve is located, is provided with the described power supply means that allow to make the station autonomous from the point of view of energy requirements, so that its functionality does not depend on the possibility of being connected, or not, to a power supply.

However, it is understood that what is described above is illustrative and not limiting, therefore any detail variations that may be necessary for technical and/or functional reasons are considered from now on within the same protection scope defined by the claims below.

1. Method for automatic operation and functional check of line valves, situated in pipelines (T) of fluid distribution networks, said line valves (Vs) being kept in an open configuration under normal operating conditions of the respective fluid distribution network, each of said valves (Vs) being associated with a rotation driver (Cr), external to the body of said valve, aimed at opening and closing said valve, a gear motor assembly (2), mechanically associated to said rotation driver (Cr), and an electronic processing and control unit (3), electrically connected to said gear motor assembly (2), aimed at controlling the latter; a transceiver apparatus (4), connected to said electronic unit (3) and to a remote communication line, aimed at transmitting and receiving data and instructions to/from a remote operating station (5); said method including cyclic operations of efficiency maintenance and functional check of each of said line valves (Vs), controlled at predefined time intervals, each of said operations comprising:
sending of input signals, transmitted by radiofrequency from said remote operating unit (5) to said electronic processing and control unit (3) provided in each of said line valves (Vs); activating of a program procedure in said processing and control unit (3) including instructions to control the partial opening and subsequent closing of said line valve (Vs);
consequent first activating of said gear motor assembly (2) by said processing and control unit (3) for a period of time necessary to make said valve (Vs) rotate in the partial closing direction of said line, by a predefined rotation angle, such as not to interrupt the flow of fluid through said valve V(s); checking the achievement of the predefined angular amplitude of rotation by means of a first sensor element (21) associated to said gear motor assembly (2) and electrically connected to said processing and control unit (3) and capable of transmitting coded information relating to the current position of said valve (Vs) to said processing and control unit; subsequent stopping of said gear motor assembly; subsequent second activation of said gear motor assembly (2) in the direction of the reopening of said line; checking of the achievement of the fully open position of said valve (Vs) by means of said first sensor element (21).

2. The method according to claim 1, wherein each of said sequences of operations further comprises a final phase of preparing a report containing at least positional data detected by said first sensor element (21) and of transmitting said report to said remote operation center (5).

3. The method according to claim 1, wherein said instructions for controlling the partial opening and subsequent closing of said valve (Vs) are transmitted remotely from said remote operation center (5) to said processing and control unit (3) via said remote communication line.

4. The method according to claim 1, wherein during the aforesaid activation phase of the gear motor assembly (2), a first sensor element (21) associated to said gear motor assembly (2) detects the angular amplitude and the direction of the rotations imposed to said rotation driver (Cr); and in that a report concerning the result of the rotating manipulations carried out on the rotation driver (Cr) of the respective ball valve (Vs) is sent by radiofrequency to said remote operating unit (5).

5. The method according to claim 1, wherein during the aforesaid activation phase of the gear motor assembly (2), a second sensor element (23) associated to said gear motor assembly (2) detects the electric power absorbed by said gear motor assembly (2) to carry out said rotations of said rotation driver (Cr); in that a report containing data relative to the value of said power consumption is transmitted to said remote operation centre (5).

6. The method according to claim 1, wherein during said activation phase of the gear motor assembly (2) at least a third sensor element (24) associated with the corresponding pipeline (T), upstream and/or downstream of said ball valve (Vs), detects the flow rate of the fluid transported by said pipeline (T), in that a report containing data relative to the value of said flow rate is transmitted to said remote operation centre (5).

7. The method according to claim 1, wherein during said activation phase of the gear motor assembly (2) at least a fourth sensor element (25) associated with the corresponding pipeline (T) upstream and/or downstream of said ball valve (Vs), detects the pressure of the flow rate of the fluid transported by said pipeline (T), in that a report concerning the value of said pressure is transmitted to said remote operation centre (5).

8. System for automatic operation and functional check of line valves, for example ball valves (Vs) situated in pipelines (T) of fluid distribution networks, said ball valves (Vs) being kept in an open configuration under normal operating conditions of the respective fluid distribution network, and being of the type provided with a rotation driver (Cr) external to the valve body aimed at opening and closing the valve, said system (1) comprising:
for each ball valve (Vs) to be operated, the gear motor assembly (2) associated with said rotation driver (Cr) of said corresponding ball valve (Vs) and aimed at manipulating it in one direction or the other;
at least one first sensor element (21) associated to said gear motor assembly (2), aimed at detecting the angular amplitude and the direction of the rotation imposed to said rotation driver (Cr) of the ball valve (Vs);
an electronic processing and control unit (3), provided to activate/deactivate said gear motor assembly (2), according to predefined modes, and to receive feedback signals provided by said at least one sensor element (21);
a radio-frequency transceiver apparatus (4) interfaced with said electronic processing and control unit (3) and aimed at communicating with a remote operation center (5), in order to send thereto a report concerning the outcome of each single rotating operation carried out on the rotation driver (Cr) of the respective ball valve (Vs).

9. The system according to claim 8, wherein a second sensor element (23) associated with said gear motor assembly (2), aimed at detecting the electric power absorbed by the latter in order to carry out the rotations by the rotation driver (Cr) and to send a corresponding signal to said electronic processing and control unit (3).

10. The system according to claim 8, wherein at least a third sensor element (24) associated with the corresponding pipeline (T) is provided upstream and/or downstream of said ball valve (Vs) and aimed at detecting the flow rate of the fluid transported by said pipeline (T) and at sending a corresponding signal to said electronic processing and control unit (3).

11. The system according to claim 8, wherein at least a fourth sensor element (25) associated with the corresponding pipeline (T) is provided upstream and/or downstream of said ball valve (Vs) and aimed at detecting the pressure of the flow of fluid transported by said pipeline (T) and at sending a corresponding signal to said electronic processing and control unit (3).

12. The system according to claim 8, further comprising a module (6) for supplying electric energy in which at least one photovoltaic panel (60), a battery charger (61) and at least one accumulator (62) are provided, the latter being aimed at supplying electric current to said gear motor assembly (2), at least a first sensor element (21), a second sensor element (23), at least a third sensor element (24), at least a fourth sensor element (25), a processing and control electronic unit (3) and a transceiver apparatus (4), during the active phases of said system (1).

13. The system according to claim 8, wherein said remote operation center (5) is supervised by an operator and is provided to send inputs to said electronic processing and control unit (3) concerning a maintenance program of said ball valve (Vs), which provides at least one partial closing and at least one subsequent immediate reopening of said ball valve.

14. The system according to claim 8, wherein said electronic processing and control unit (3) incorporates a software which autonomously governs a program of keeping operative the respective ball valve (Vs), which includes at least one partial closing and at least one subsequent immediate reopening of the latter, at predefined time interval, with consequent transmission, to said remote operation center (5), in real time, of a report concerning the outcome of each single operation performed on said rotation driver (Cr) of the ball valve (Vs).

15. The system according to claim 8, wherein said transceiver apparatus (4) is connected to a cellular telephone network (R) or a satellite telephone network.
